(19) United States
(12) Patent Application Publication
(10) Pub. No.: US 2003/0011547 A1
(43) Pub. Date: Jan. 16, 2003

(54) Image display device

(76) Inventors: Youichi Igarashi, Mobara (JP); Yoshio Oowaki, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/150,936

(22) Filed: May 21, 2002

(30) Foreign Application Priority Data
Jul. 10, 2001 (JP) 2001-209256

(51) Int. Cl. G09G 3/36; G09G 5/00

(52) U.S. Cl. 345/87

(57) ABSTRACT

Even in a liquid crystal display device finished as a product, EMI countermeasures and power saving are realized according to the use environment of an electronic apparatus in which to mount the liquid crystal display device. A timing converter mounted on an interface printed circuit board of the liquid crystal display device is provided with a display mode selecting terminal. A display mode selecting signal which varies the frequency of a pixel clock signal for an image signal is applied to the display mode selecting terminal from the outside, thereby varying the frequency of the pixel clock signal.

### BACKGROUND OF THE INVENTION

1. Field of the Invention

The present invention relates to an image display device.

2. Background Art

In one example of an image display device is as follows. Driver circuits which have data-line driver circuits and scanning-line driver circuits are mounted at the periphery of a liquid crystal panel which constitutes an image display screen, and an interface printed circuit board which supplies various signals for display to those driver circuits is secured at the periphery of the liquid crystal panel. The interface printed circuit board including a display control device as a timing converter and power source circuit. The timing converter generates display data for displaying an image on a liquid crystal panel by receiving an image signal (display signal), that is various timing signals including pixel clock signals from an external signal source, and a power source voltage. The semiconductor integrated circuits constitute a power source part.

### SUMMARY OF THE INVENTION

In such an image display device whose resolution is becoming increasingly high, means for restraining electromagnetic radiation interference with environment, so-called EMI countermeasures, are adopted. EMI countermeasures are chiefly taken by setting parameters such as the case structure of the liquid crystal display device, the electromagnetic shielding structures of data-line supply lines and the frequency of a pixel clock signal. However, during product shipment, it may become necessary to take further EMI countermeasures for a liquid crystal display device subjected to EMI countermeasures on the assumption that it is mounted in a notebook personal computer, when the liquid crystal display device is to be again mounted in another electronic apparatus, or according to the use environment of the liquid crystal display device. In such a case, it is not realistic to alter the parameters of the liquid crystal display device, because the design change of the liquid crystal display device itself is needed.

There is a great demand for larger power saving to be achieved in this kind of image display device. However, power saving is difficult to achieve after the liquid crystal display device has been finished as a product. These facts have heretofore been problems to be solved.

Therefore, the invention solves the problems of the related art, and provides an image display device which enables the above-described EMI countermeasures and power saving to be realized even in a liquid crystal display device finished as a product, according to the use environment of an electronic apparatus in which to mount the liquid crystal display device.

Therefore, the invention provides a construction in which a timing converter mounted on an interface printed circuit board of a liquid crystal display device is provided with a special terminal and a signal which varies the frequency of a pixel clock signal for an image signal is applied to the special terminal from the outside. In addition, the invention provides a construction having a circuit capable of externally varying a power source voltage to be supplied from the timing converter to driver circuits of a liquid crystal panel. Representative constructions of the invention will be described below.

(1) A liquid crystal display device includes data-line driver circuits and scanning-line driver circuits mounted at the periphery of a liquid crystal panel, and an interface printed circuit board provided in the vicinity of the liquid crystal panel. The interface printed circuit board is provided with a display control device which is made of a timing converter and a plurality of semiconductor integrated circuits. The timing converter receives a display signal from an external signal source, various timing signals including pixel clock signals, and a power source voltage, and generates display data for displaying an image on the liquid crystal panel. The semiconductor integrated circuits constitute a power source part. A semiconductor integrated circuit which constitutes the timing converter has a display mode selecting terminal for switching the frequency of a pixel clock for an image signal to be displayed on the liquid crystal panel, between a high speed and a low speed. The semiconductor integrated circuit varies the frequency of the pixel clock signal for the image signal to be displayed on the liquid crystal panel, according to a display mode selecting signal applied to the display mode selecting terminal from the outside.

In above construction, the display mode selecting terminal may be connected to either fixed potential which is provided on the interface printed circuit board and corresponds to the display mode selecting signal. According to this construction, EMI countermeasures according to the use environment of an electronic apparatus in which to mount the liquid crystal display device can be set during the mounting of the liquid crystal display device to the electronic apparatus.

(2) A liquid crystal display device includes data-line driver circuits and scanning-line driver circuits mounted at the periphery of a liquid crystal panel, and an interface printed circuit board provided in the vicinity of the liquid crystal panel. The interface printed circuit board is provided with a timing converter and a plurality of semiconductor integrated circuits. The timing converter receives a display signal from an external signal source, various timing signals including pixel clock signals, and a power source voltage, and generates display data for displaying an image on the liquid crystal panel. The semiconductor integrated circuits constitute a power source part. A display control device has an operating-voltage adjusting circuit which externally adjusts an operating voltage for the data-line driving circuits of the liquid crystal panel, and varies the operating voltage for the liquid crystal panel according to an operating-voltage adjusting signal applied to the operating-voltage adjusting circuit from the outside.

The operating-voltage adjusting signal applied to the operating-voltage adjusting circuit from the outside can be connected to a fixed potential which is provided on the interface printed circuit board and corresponds to either level of the operating voltage of the liquid crystal panel. According to this construction, the power saving of the liquid crystal display device can be realized after the liquid crystal display device has been mounted in an electronic apparatus, and the EMI countermeasures can be taken by decreasing the operating voltage of each of the data-line driver circuits. Incidentally, the invention is not limited to either of the above-described constructions or to any of the constructions of embodiments which will be described later, and it goes without saying that various modifications can be made without departing from the technical idea of the invention.

Therefore, the invention can be applied to any of the following constructions.

(3) An image display device includes at least a plurality of data lines, a plurality of gate lines, data-line driver circuits electrically connected to the data lines, scanning-line driver circuits electrically connected to the gate lines, an interface printed circuit board, and a controller provided on the interface printed circuit board. The controller has a display mode selecting terminal, and is capable of varying a clock frequency to be supplied from the controller to the data-line driver circuits, according to a voltage applied to the display mode selecting terminal.

Even with this construction, it is possible to take EMI countermeasures.

(4) In construction (3), the voltage applied to the display mode selecting terminal is supplied from outside the image display device.

In this construction, external control is enabled.

(5) In construction (3), the voltage applied to the display mode selecting terminal is given by either potential on the interface printed circuit board.

In this construction, presetting is enabled, whereby it is possible to cope with the demand of each customer

(6) In construction (3), the clock frequency has a high-speed state and a low-speed state.

(7) In construction (6), The above-described construction also has a memory area in which display data is temporarily stored when the clock frequency is in the low-speed state.

The difference between clocks can be absorbed, whereby the effect of EMI reduction can be obtained.

(8) In construction (3), the clock frequency to be supplied to the data-line driver circuits is lower than a clock frequency to be applied to the image display device from outside the image display device.

In this construction, an external standardized normal signal is used and the frequency of an internal signal is decreased, whereby it is possible to strengthen EMI countermeasures to a further extent.

(9) In construction (5), the either potential on the interface printed circuit board is one of a ground potential and an operating potential.

By using the ground potential or the operating potential to set the potential, it is possible to set a stable potential resistant to noise and it is possible to prevent unintended switching between display modes due to external noise, whereby an image display device resistant to noise can be obtained.

(10) An image display device includes at least a plurality of data lines, a plurality of gate lines, data-line driver circuits electrically connected to the data lines, scanning-line driver circuits electrically connected to the gate lines, an interface printed circuit board, and an operating-voltage adjusting circuit provided on the interface printed circuit board. The operating-voltage adjusting circuit has an operating-voltage adjusting terminal capable of controlling the operating-voltage adjusting circuit, and the operating-voltage adjusting circuit is capable of varying a voltage to be supplied to at least either the data-line driver circuits or the scanning-line driver circuits, according to a voltage applied to the operating-voltage adjusting terminal.

In the above-described construction, a power saving of the image display device can be achieved.

(11) In construction (10), the voltage applied to the operating-voltage adjusting terminal is supplied from outside the image display device.

In this construction, an electric-power mode can be set from the outside.

(12) In construction (10), the voltage applied to the operating-voltage adjusting terminal is given by either potential on the interface printed circuit board.

In this construction, image quality and power consumption can be set according to the demand of each customer.

(13) In construction (10), the operating-voltage adjusting circuit is capable of varying a resistance value according to the voltage applied to the operating-voltage adjusting terminal.

In this construction, the operating voltage can be varied with a resistor which is an inexpensive element, or by the use of an integrated circuit.

(14) In construction (13), aspect, the operating-voltage adjusting circuit varies the resistance value with an analog switch.

(15) In construction (14), the operating-voltage adjusting circuit has a plurality of resistors as the analog switch, and is capable of switching the state of connection of the resistors between a series state and a parallel state.

In this construction, the resistance value can be greatly varied with a simple construction.

(16) In construction (12), the either potential on the interface printed circuit board is one of a ground potential and an operating potential.

By using the ground potential or the operating potential to set the potential, it is possible to set a stable potential resistant to noise and it is possible to prevent unintended switching between display modes due to external noise, whereby an image display device resistant to noise can be obtained.

(17) In construction (10), the voltage to be supplied to at least either the data-line driver circuits or the scanning-line driver circuits is higher when a voltage from an external power source is supplied than when an internal power source is used.

In this construction, during driving using the external power source whose power consumption is not required to be greatly reduced, the voltage can be increased to enhance image quality, whereas during driving using the internal power source whose power consumption is directly linked to the period of operating time, the voltage can be decreased to reduce the power consumption.

(18) An image display device includes at least a plurality of data lines, a plurality of gate lines, data-line driver circuits electrically connected to the data lines, and scanning-line driver circuits electrically connected to the gate lines. The image display device is capable of coping with driving using supply of a voltage from an external power source and driving using an internal power source, and a voltage to be supplied to at least either the data-line driver circuits and the scanning-line driver circuits is lower during the driving using the supply of the voltage from the external power source than during the driving using the internal power source.

In this construction, during driving using the external power source whose power consumption is not required to be greatly reduced, the voltage can be increased to enhance image quality, whereas during driving using the internal power source whose power consumption is directly linked to the period of operating time, the voltage can be decreased to reduce the power consumption.

(19) In construction (18), the image display device is a notebook personal computer.

This construction can serve a great advantage by being used in the notebook personal computer.

(20) An image display device includes at least a plurality of data lines, a plurality of gate lines, data-line driver circuits electrically connected to the data lines, scanning-line driver circuits electrically connected to the gate lines, an interface printed circuit board, and a controller and an operating-voltage adjusting circuit which are provided on the interface printed circuit board. The controller has a display mode selecting terminal, and the controller is capable of varying a clock frequency to be supplied from the controller to the data-line driver circuits, according to a voltage applied to the display mode selecting terminal. The operating-voltage adjusting circuit has an operating-voltage adjusting terminal capable of controlling the operating-voltage adjusting circuit, and the operating-voltage adjusting circuit is capable of varying a voltage to be supplied to at least either the data-line driver circuits or the scanning-line driver circuits, according to a voltage applied to the operating-voltage adjusting terminal.

In this construction, the above-described construction can serve a far greater effect of EMI reduction and a far greater effect of power consumption reduction. This is because a decrease in clock frequency also contributes to a lowering in power consumption and a reduction in voltage also contributes to a reduction in EMI.

(21) In construction (20), the voltage to be supplied to at least either the data-line driver circuits or the scanning-line driver circuits is high when the clock frequency is high.

In this construction, the image quality during high-quality image display can be further improved, and the power consumption during low power consumption can be further decreased.

(22) In construction (20), a voltage is supplied from the controller to the operating-voltage adjusting terminal, the voltage differing according to the voltage applied to the display mode selecting terminal.

In this construction, the clock frequency and the voltage can be simultaneously controlled on the basis of one external or internal signal.

Further aspects of the invention will become apparent from this specification containing claims or the accompanying drawings.

### BRIEF DESCRIPTION OF THE DRAWINGS

The invention will become more readily appreciated and understood from the following detailed description of preferred embodiments of the invention when taken in conjunction with the accompanying drawings, in which:

FIG. 1 is a diagrammatic view of a timing converter, aiding in describing a first embodiment of a liquid crystal display device according to the invention;

FIG. 2 is an explanatory view of the state of display to be provided on a liquid crystal panel according to a display mode selecting signal in the first embodiment;

FIG. 3 is a construction diagram of a display control device, aiding in describing a second embodiment of the liquid crystal display device according to the invention;

FIG. 4 is a construction diagram of the essential circuit of a display control device, aiding in describing a third embodiment of the liquid crystal display device according to the invention;

FIG. 5 is a construction diagram of the essential circuit of a display control device, aiding in describing a fourth embodiment of the liquid crystal display device according to the invention;

FIG. 6 is an explanatory view of the construction and the drive system of a thin film transistor type liquid crystal display device to which the invention is applied;

FIG. 7 is a developed perspective view aiding in describing the entire construction of the liquid crystal display device according to the invention;

FIG. 8 is a perspective view of a notebook type computer which is one example of an electronic apparatus in which the liquid crystal display device according to the invention is mounted; and

FIG. 9 is a front view of a display monitor which is another example of the electronic apparatus in which the liquid crystal display device according to the invention is mounted.

### DETAILED DESCRIPTION OF THE INVENTION

Preferred embodiments of the invention will be described below in detail with reference to the accompanying drawings.

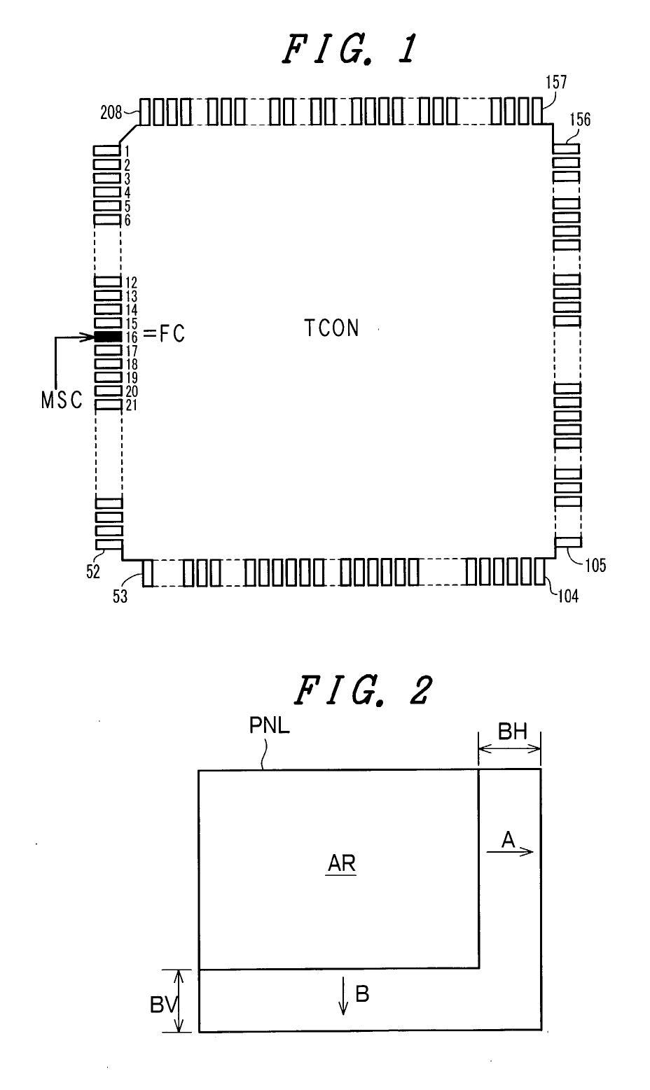

FIG. 1 is a diagrammatic view of a timing converter, aiding in describing a first embodiment of a liquid crystal display device according to the invention. This timing converter is mounted on an interface printed circuit board which is provided in the vicinity of a liquid crystal panel. FIG. 1 shows only the arrangement of terminals of a timing converter TCON. The number of the terminals (pins) of the shown timing converter TCON is 208.

As shown in FIG. 1, the timing converter TCON has power source (3.3 V) terminals, grounding terminals, input terminals and output terminals, each of which is assigned any one of terminal numbers 1 through 208. A display mode selecting terminal FCK is provided among those terminals. In the first embodiment, terminal number 16 is assigned to the display mode selecting terminal FCK. When a display mode selecting signal MSC which switches between a high speed and a low speed the frequency of a pixel clock for an image signal to be displayed on the liquid crystal panel, the timing converter TCON switches the image signal between a high-speed frequency and a low-speed frequency.

In the first embodiment, the timing converter TCON is set so that when the display mode selecting signal MSC goes to “0”, the pixel clock frequency becomes a high speed of 162 MHz, whereas when the display mode selecting signal MSC goes to “1”, the pixel clock frequency becomes a low speed of 135 MHz. Incidentally, when the display mode selecting terminal FCK is in its grounded state, the display mode selecting signal MSC is at “0”, whereas when a power source voltage (3.3 V) is provided at the display mode selecting terminal FCK, the display mode selecting signal MSC is at “1”. The setting of the display mode selecting signal MSC to “0” or “1” can be realized by connecting the display mode selecting signal MSC to ground-potential wiring or operating-voltage wiring which lies on the interface printed circuit board.

FIG. 2 is an explanatory view of the state of display to be provided on the liquid crystal panel according to the display mode selecting signal MSC in the first embodiment. In FIG. 2, it is assumed that when the pixel clock signal is at 162 MHz for high-speed display mode, an area AR occupies the entire screen of a liquid crystal panel PNL. In FIG. 2, a horizontal blanking signal is diagrammatically shown at BH, and a vertical blanking signal at BV. When the display mode selecting signal MSC is set to “1”, the timing converter TCON reduces the period of the horizontal blanking signal BH and the period of the vertical blanking signal BV in the directions of arrows A and B, respectively.

Accordingly, the timing at which each pixel signal of an image signal is supplied to a corresponding one of the pixels of the liquid crystal panel PNL is delayed on the screen by the periods of the horizontal blanking signal BH and the vertical blanking signal BV, whereby the horizontal size and the vertical size of an image to be displayed on the screen of the liquid crystal panel PNL is enlarged.

In this manner, according to the first embodiment, normal display can be provided with respect to both high- and low-speed pixel clock signals according to the display mode selecting signal MSC to be applied from the outside, without the need to alter the parameters of the liquid crystal display device, and EMI countermeasures can be further improved by selecting a low-speed mode according to environment.

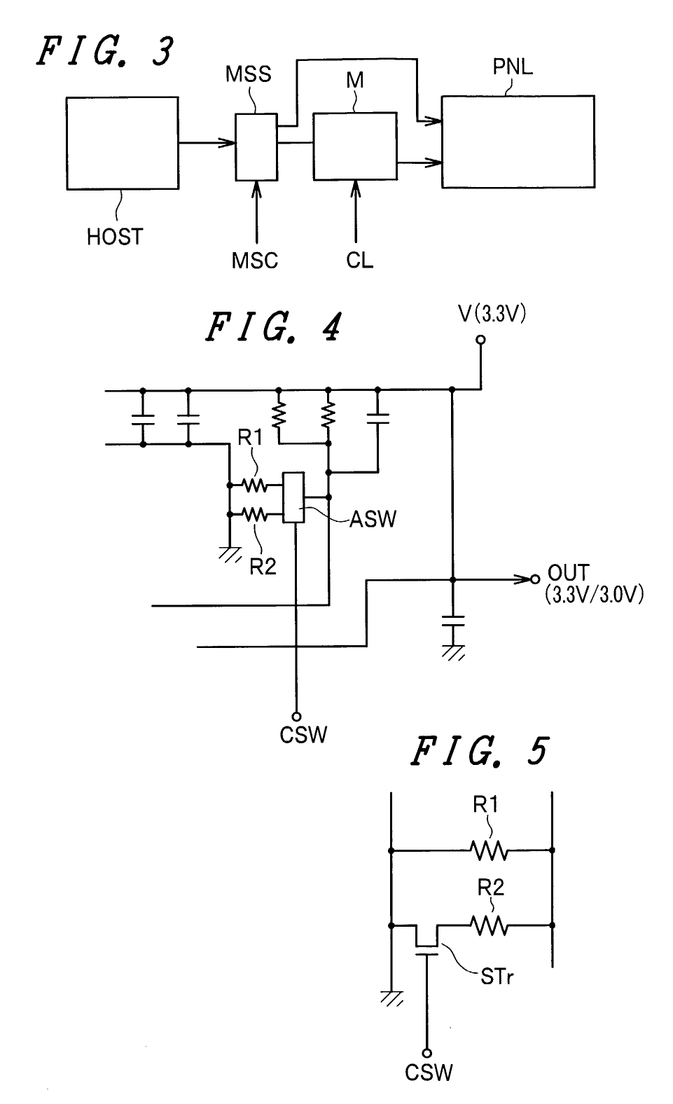

FIG. 3 is a construction diagram of a display control device, aiding in describing a second embodiment of the liquid crystal display device according to the invention. In the second embodiment, in the case of a low-speed mode, a display signal which is inputted from an external signal source HOST is temporarily stored in a memory M, and the stored display signal is read out with a low-speed read-out clock and is supplied to the liquid crystal panel PNL. Incidentally, during a high-speed mode, the display signal from the external signal source HOST is supplied to the liquid crystal panel PNL without being passed through the memory M.

Specifically, the display signal inputted from the external signal source HOST is switched between the high-speed mode and the low-speed mode by the display mode selecting signal MSC applied to a display mode selecting circuit MSS from the outside. In the case where the display mode selecting signal MSC is “0”, the high-speed mode is selected and the display signal inputted from the external signal source HOST is directly supplied to the liquid crystal panel PNL. On the other hand, in the case where the display mode selecting signal MSC is “1”, the low-speed mode is selected and the display signal inputted from the external signal source HOST is temporarily written into the memory M. A clock signal for this writing has a high-speed frequency (for example, 162 MHz). The written display signal is read out with a read-out clock signal CLK of low speed (for example, 135 MHz).

The setting of the display mode selecting signal MSC to “0” or “1” can be realized by connecting the display mode selecting signal MSC to ground-potential wiring or operating-voltage wiring which lies on the interface printed circuit board. According to the second embodiment, proper display of image can be provided with respect to both high-and low-speed pixel clock signals according to the display mode selecting signal MSC to be applied from the outside, without the need to alter the parameters of the liquid crystal display device, and EMI countermeasures can be further improved by selecting the low-speed mode according to environment.

FIG. 4 is a construction diagram of the essential circuit of a display control device, aiding in describing a third embodiment of the liquid crystal display device according to the invention. In the third embodiment, EMI countermeasures are realized by decreasing the power source voltage to be supplied to driver circuits of the liquid crystal panel. In the liquid crystal display device, it is assumed that an operating voltage for data line driver circuits (i.e., drain drivers) of its liquid crystal panel is 3.3 V. In the case where the use environment of an electronic apparatus in which the liquid crystal display device is mounted requires further EMI countermeasures, the operating voltage is decreased to, for example, 3.0 V.

As shown in FIG. 4, an analog switch ASW which is connected in series with a parallel circuit made of resistors R1 and R2 is provided between the power source voltage and an output terminal OUT from which to output the operating voltage to the driver circuits. For example, the 3.3-V operating voltage is outputted to the driver circuits of the liquid crystal panel from the resistor R1, whereas the 3.0-V operating voltage is outputted to the resistor R2. A switching signal CSW which is inputted from the outside switches the analog switch ASW, thereby switching the resistor R1 and the resistor R2 therebetween.

According to the third embodiment, in the case where further EMI countermeasures are to be taken in the use environment of the electronic apparatus in which the liquid crystal display device is mounted, the resistor R2 is selected. Since the operating voltage for the driver circuits is decreased, EMI is decreased, and at the same time, power consumption is also decreased. The analog switch ASW may be connected to a fixed potential in a work process during the mounting of the liquid crystal display device to the electronic apparatus, or may also be mounted as a user setting switch on the interface printed circuit board. Otherwise, the analog switch ASW may also be set by software through the manipulation of a keyboard or the like.

FIG. 5 is a construction diagram of the essential circuit of a display control device, aiding in describing a fourth embodiment of the liquid crystal display device according to the invention. The fourth embodiment is constructed in such a manner that the circuit shown in FIG. 5 is substituted for the section shown in FIG. 4 which includes the resistors R1 and R2 and the analog switch ASW. In the third embodiment, the two resistors R1 and R2 are switched therebetween to vary the operating voltage for the driver circuits, but in the fourth embodiment, the two resistors R1 and R2 are switched between series connection and parallel connection.

Specifically, the 3.3-V operating voltage is outputted to the driver circuits of the liquid crystal panel from the resistor R1, and a series circuit made of the resistor R2 and a switching element STr is connected in parallel with the resistor R1. The switching signal CSW is inputted to a control terminal of the switching element STr from the outside. When the switching element STr is made conductive by the switching signal CSW, the resistor R1 and the resistor R2 are connected in parallel, so that the combined resistance of the resistors R1 and R2 lowers and the 3.0-V operating voltage is outputted to the output terminal OUT. According to the fourth embodiment as well, in the case where further EMI countermeasures are to be taken in the use environment of the electronic apparatus in which the liquid crystal display device is mounted, the resistor R2 is selected. Since the operating voltage for the driver circuits is decreased, EMI is decreased, and at the same time, power consumption is also decreased.

The switching signal CSW to be applied to the control terminal of the switching element STr may be directly connected to appropriate potential wiring on the interface printed circuit board, or may also be mounted as a user setting switch on the interface printed circuit board. Otherwise, the switching signal CSW may also be set by software through the manipulation of a keyboard or the like.

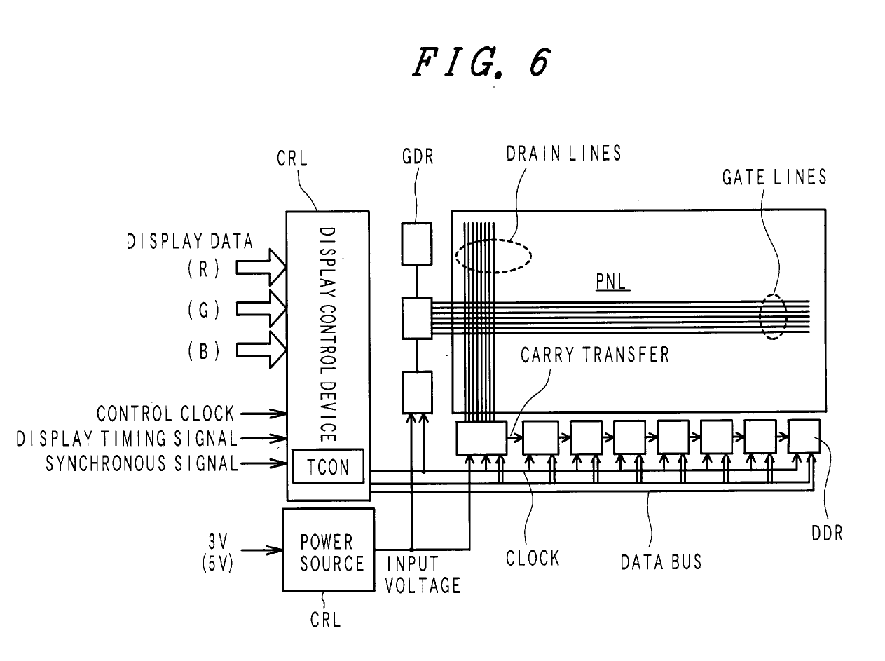

An example of the entire construction of the liquid crystal display device according to the invention and an applied example thereof will be described below. FIG. 6 is an explanatory view of the construction and the drive system of a thin film transistor type liquid crystal display device to which the invention is applied. This liquid crystal display device has a printed circuit board on which are mounted driver circuits (semiconductor chips) for data lines (drain signal lines, drain lines or video signal lines), i.e., drain drivers DDR, and a printed circuit board on which are mounted driver circuits (semiconductor chips) for scanning lines (gate signal lines or gate lines), i.e., gate drivers GDR. The printed circuit boards are disposed at the periphery of the liquid crystal panel PNL.

The liquid crystal display device is also provided with an interface printed circuit board on which a display control device CRL and a power source circuit PWU are mounted. The display control device CRL is a display control unit for supplying display signals for image display (display data or image data), clock signals, grayscale voltages and the like to the drain drivers DDR and the gate drivers GDR. The circuit board (printed circuit board) is not shown. Incidentally, there is also a liquid crystal display device of the type in which the semiconductor chips are directly mounted on a glass substrate constituting the liquid crystal panel PNL, instead of the printed circuit board provided with the data-line driver circuits and the printed circuit board provided with the scanning-line driver circuits.

In FIG. 6, various signals, such as display data, a control signal clock, a display timing signal and a synchronous signal, which are supplied from an external signal source (host) such as a computer, a personal computer or a TV receiver circuit, are inputted to the display control device CRL. The interface printed circuit board which constitutes the display control device CRL is provided with a grayscale reference voltage generating part, the timing converter TCON and the like, and converts the display data supplied from the outside into data of the type which conforms to the format of display on the liquid crystal panel PNL. The terminals of the timing converter TCON and its associated circuit are provided with the arrangement and construction of any of the above-described embodiments of the invention.

Display data and clock signals for the gate drivers GDR and the drain drivers DDR are supplied as shown in FIG. 6. A carry output from each of the drain drivers DDR is applied to the carry input of the next one on an unmodified basis. The interface printed circuit board or the timing converter TCON is provided with any of the constructions described above in connection with the embodiments of the invention.

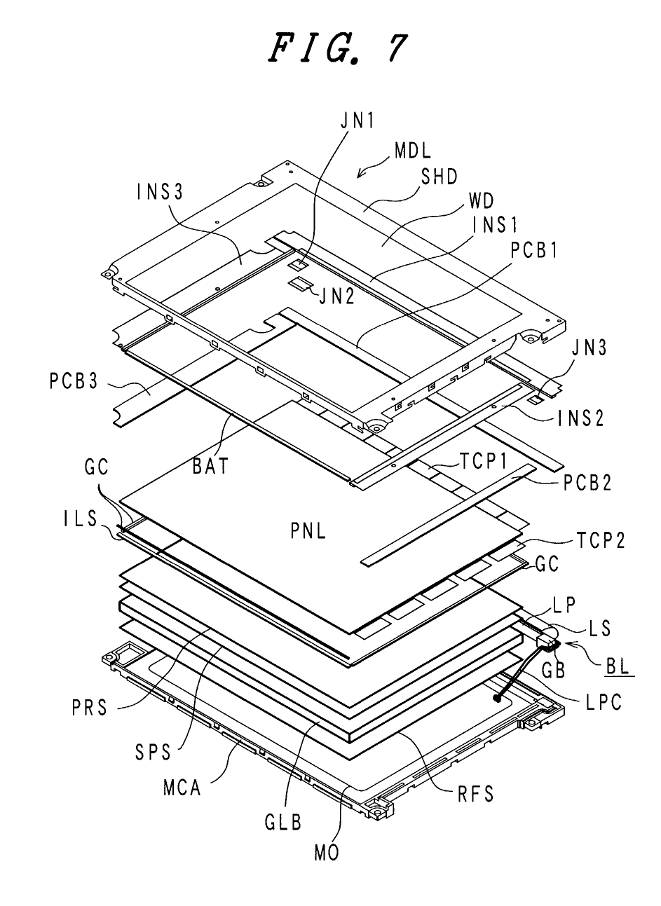

FIG. 7 is a developed perspective view aiding in describing the entire construction of the liquid crystal display device according to the invention. FIG. 7 illustrates a specific structure of the liquid crystal display device (hereinafter referred to as a liquid crystal display module MDL in which a liquid crystal panel formed of two substrates SUB1 and SUB2 stuck to each other, a driver unit, a back-light and other constituent members are integrated).

In FIG. 7, sign SHD denotes a shield case (also called a metal frame) made from a metal plate; sign WD a display window; signs INS1 to INS3 insulating sheets; signs PCB1 to PCB3 circuit boards which constitutes a driver unit (PCB1: a drain side circuit board, PCB2: a gate side circuit board, and PCB3: an interface circuit board); signs JN1 to JN3 joiners for electrically connecting the circuit boards PCB1 to PCB3; signs TCP1 and TCP2 tape carrier packages; sign PNL a liquid crystal panel; sign GC a rubber cushion; sign ILS a light shield spacer; sign PRS a prism sheet; sign SPS a diffusing sheet; sign GLB a light guide plate; sign RFS a reflecting sheet; sign MCA a lower case (a mold frame) formed by integral molding; sign MO an aperture of the lower case MCA; sign LP a fluorescent lamp; sign LPC a lamp cable; sign GB a rubber bush which supports the fluorescent lamp LP; sign BAT a double-faced adhesive tape; and sign BL a backlight made of the fluorescent lamp LP, the light guide plate GLB and the like. The diffusing sheet members are stacked in the shown arrangement to assemble the liquid crystal display module MDL.

The liquid crystal display MDL has two kinds of accommodating/holding members, the lower frame MCA and the shield case SHD, and is constructed by joining the shield case SHD and the lower case MCA together. The insulating sheets INS1 to INS3, the circuit boards PCB1 to PCB3 and the liquid crystal panel PNL are fixedly accommodated in the shield case SHD, and the backlight BL made of the fluorescent lamp LP, the light guide plate GLB, the prism sheet PRS and the like is accommodated in the lower case MCA.

Semiconductor integrated circuits (semiconductor chips) for driving the individual pixels of the liquid crystal panel PNL are mounted on the circuit boards PCB1 and PCB2, while semiconductor chips for receiving video signals from an external host and control signals such as timing signals as well as the timing converter TCON for processing timing and generating clock signals are mounted on the interface circuit board PCB3. The mounting structure of the semiconductor chips on the timing converter TCON is as described above in connection with the embodiments of the invention.

The interface circuit board PCB3 and the circuit board PCB1 and PCB2 are multilayer printed circuit boards, and a clock signal line CLL is formed as an inner-layer line in each of the interface circuit board PCB3 and the circuit boards PCB1 and PCB2. Incidentally, in FIG. 7, the drain side circuit board PCB1, the gate side circuit board PCB2 and the interface circuit board PCB3, all of which serve to drive thin film transistors TFT, are connected to the liquid crystal panel PNL by the tape carrier packages TCP1 and TCP2. The individual circuit boards are interconnected by the joiners JN1, JN2 and JN3.

However, the above-described construction is not limitative, and in a liquid crystal display device which adopts a mounting scheme called FCA or COG in which driver circuits (semiconductor integrated circuits) are directly provided at the periphery of either substrate of a liquid crystal panel, flexible printed circuit boards are used in place of the circuit boards PCB1 and PCB2. In this case, the tape carrier packages TCP1 and TCP2 and the joiners JN1, JN2 and JN3 are not particularly needed.

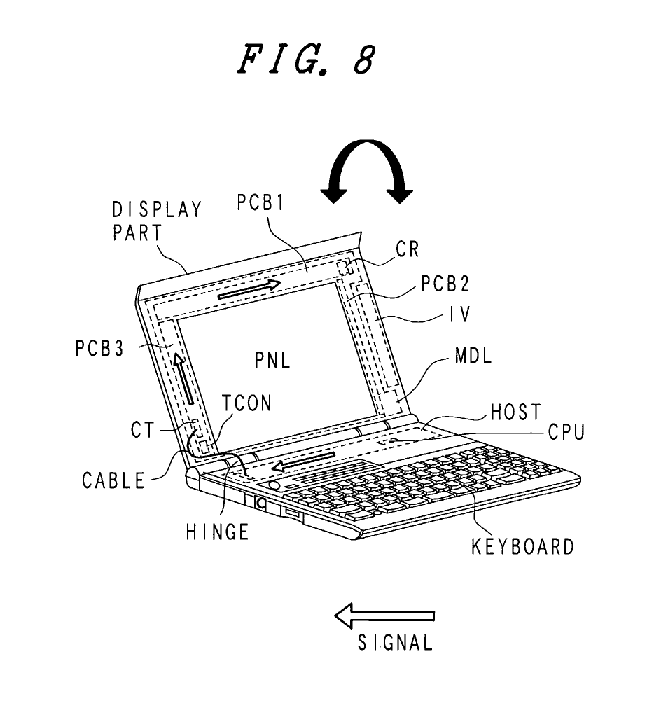

FIG. 8 is a perspective view of a notebook type computer which is one example of the electronic apparatus in which the liquid crystal display device according to the invention is mounted. This notebook type computer (portable personal computer) is made of a keyboard part (main-frame part) and a display part which is joined to the keyboard part by hinges. The keyboard part accommodates signal generating functions such as a keyboard, a host (host computer) and a CPU. The display part has the liquid crystal panel PNL, and the driver circuit boards PCB1 and PCB2, the driver circuit board PCB3 provided with the control chip TCON, and an inverter power source board which is a backlight power source are mounted at the periphery of the liquid crystal panel PNL.

The liquid crystal display module described above with reference to FIG. 7, which integrally includes the liquid crystal panel PNL, the various circuit boards PCB1, PCB2 and PCB3, the inverter power source board and the backlight, is mounted in the notebook type computer.

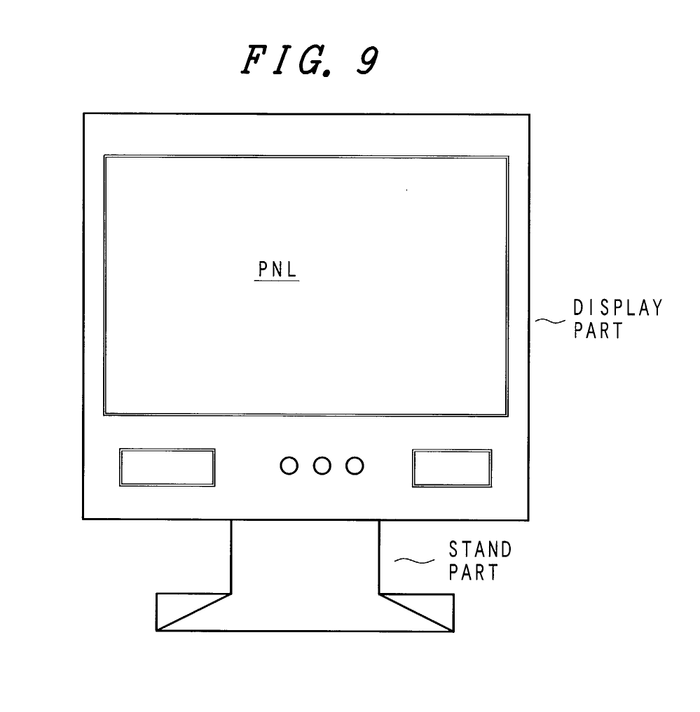

FIG. 9 is a front view of a display monitor which is another example of the electronic apparatus in which the liquid crystal display device according to the invention is mounted. This display monitor is made of a display part and a stand part, and the liquid crystal display device according to the invention is mounted in the display part. Incidentally, a host computer or a television receiver circuit may be built in the stand part of this display monitor.

The advantage of the invention can also be realized by the following construction.

The voltage to be supplied to at least either the data-line driver circuits or the scanning-line driver circuits may be made higher when a voltage from an external power source is supplied, than when an internal power source is used. In this case, during driving using the external power source whose power consumption is not required to be greatly reduced, the voltage can be increased to enhance image quality, whereas during driving using the internal power source whose power consumption is directly linked to the period of operating time, the voltage can be decreased to reduce the power consumption.

The invention may also be applied to a notebook type personal computer such as that shown in FIG. 8 in the following manner.

In an image display device which includes at least a plurality of data lines, a plurality of gate lines, data-line driver circuits electrically connected to the data lines, and scanning-line driver circuits electrically connected to the gate lines, the image display device is capable of coping with driving using supply of a voltage from an external power source and driving using an internal power source, and a voltage to be supplied to at least either the data-line driver circuits and the scanning-line driver circuits may be made lower during the driving using the supply of the voltage from the external power source than during the driving using the internal power source.

Incidentally, since the above description can be fully understood without any special illustration, illustration is omitted. In this case, during driving using the external power source whose power consumption is not required to be greatly reduced, the voltage can be increased to enhance image quality, whereas during driving using the internal power source whose power consumption is directly linked to the period of operating time, the voltage can be decreased to reduce the power consumption.

The notebook type personal computer is connected to an AC power source in normal use. In this case, since the notebook type personal computer is used equivalently to a desktop type personal computer, higher image quality is more desirable. On the other hand, in the case where the notebook type personal computer is driven by the internal power source, for example during outdoor use, the period of driving time of the internal power source needs to be extended, and the power consumption needs to be decreased. In the invention, these demands are compatibly realized.

The ideal of the invention may also be realized in the following manner.

In an image display device which includes at least a plurality of data lines, a plurality of gate lines, data-line driver circuits electrically connected to the data lines, scanning-line driver circuits electrically connected to the gate lines, an interface printed circuit board and controller and an operating-voltage adjusting circuit provided on the interface printed circuit board, the controller having a display mode selecting terminal, the controller being cable of varying a clock frequency to be supplied from the controller to the data line driver circuits, according to a voltage applied to the display mode selecting terminal, the operating-voltage adjusting circuit has an operating-voltage adjusting terminal capable of controlling the operating-voltage adjusting circuit, and the operating-voltage adjusting circuit is capable of varying a voltage to be supplied to at least either the data-line driver circuits or the scanning-line driver circuits, according to a voltage applied to the operating-voltage adjusting terminal.

The above-described construction can be readily understood from the descriptions and the drawings of the other constructions stated previously in this specification. The above-described construction can serve a far greater effect of EMI reduction and a far greater effect of power consumption reduction. This is because a decrease in clock frequency also contributes to a lowering in power consumption and a reduction in voltage also contributes to a reduction in EMI.

In the above-described construction, the voltage to be supplied to at least either the data-line driver circuits or the scanning-line driver circuits may be made high when the clock frequency is high. In this case, the image quality during high-quality image display can be further improved, and the power consumption during low power consumption can be further decreased.

The above-described construction may also adopt an arrangement in which a voltage is supplied from the controller to the operating-voltage adjusting terminal and the voltage may be made different according to the voltage applied to the display mode selecting terminal. Since the clock frequency and the voltage can be simultaneously controlled on the basis of one external or internal signal, a simplification in structure and a simplification in control are realized.

As is apparent from the foregoing description, according to the invention, EMI countermeasures and power saving for a liquid crystal display device can be realized with an external display mode switching signal or an external operating-voltage varying signal, and the liquid crystal display device can be applied to different use environments, whereby it is possible to provide a liquid crystal display device which enables realization of EMI countermeasures and power saving even after having been finished as a product.

What is claimed is:

1. An image display device comprising at least:
a plurality of data lines;
a plurality of gate lines;
data-line driver circuits electrically connected to the data lines;
scanning-line driver circuits electrically connected to the gate lines;
an interface printed circuit board; and
a controller provided on the interface printed circuit board;
the controller having a display mode selecting terminal, the controller being capable of varying a clock frequency to be supplied from the controller to the data-line driver circuits, according to a voltage applied to the display mode selecting terminal.

2. An image display device according to claim 1, wherein the voltage applied to the display mode selecting terminal is supplied from outside the image display device.

3. An image display device according to claim 1, wherein the voltage applied to the display mode selecting terminal is given by either potential on the interface printed circuit board.

4. An image display device according to claim 1, wherein the clock frequency has a high-speed state and a low-speed state.

5. An image display device according to claim 4, further comprising a memory area in which display data is temporarily stored when the clock frequency is in the low-speed state.

6. An image display device according to claim 1, wherein the clock frequency to be supplied to the data-line driver circuits is lower than a clock frequency to be applied to the image display device from outside the image display device.

7. An image display device according to claim 3, wherein the either potential on the interface printed circuit board is one of a ground potential and an operating potential.

8. An image display device comprising at least:
a plurality of data lines;
a plurality of gate lines;
data-line driver circuits electrically connected to the data lines;
scanning-line driver circuits electrically connected to the gate lines;
an interface printed circuit board; and
an operating-voltage adjusting circuit provided on the interface printed circuit board;
the operating-voltage adjusting circuit having an operating-voltage adjusting terminal capable of controlling the operating-voltage adjusting circuit, the operating-voltage adjusting circuit being capable of varying a voltage to be supplied to at least either the data-line driver circuits or the scanning-line driver circuits, according to a voltage applied to the operating-voltage adjusting terminal.

9. An image display device according to claim 8, wherein the voltage applied to the operating-voltage adjusting terminal is supplied from outside the image display device.

10. An image display device according to claim 8, wherein the voltage applied to the operating-voltage adjusting terminal is given by either potential on the interface printed circuit board.

11. An image display device according to claim 8, wherein the operating-voltage adjusting circuit is capable of varying a resistance value according to the voltage applied to the operating-voltage adjusting terminal.

12. An image display device according to claim 11, wherein the operating-voltage adjusting circuit varies the resistance value with an analog switch.

13. An image display device according to claim 11, wherein the operating-voltage adjusting circuit has a plurality of resistors as the analog switch, and is capable of switching the state of connection of the resistors between a series state and a parallel state.

14. An image display device according to claim 10, wherein the either potential on the interface printed circuit board is one of a ground potential and an operating potential.

15. An image display device according to claim 8, wherein the voltage to be supplied to at least either the data-line driver circuits or the scanning-line driver circuits is higher when a voltage from an external power source is supplied than when an internal power source is used.

16. An image display device comprising at least:
a plurality of data lines;
a plurality of gate lines;
data-line driver circuits electrically connected to the data lines; and
scanning-line driver circuits electrically connected to the gate lines;
the image display device being capable of coping with driving using supply of a voltage from an external power source and driving using an internal power source, a voltage to be supplied to at least either the data-line driver circuits and the scanning-line driver circuits being lower during the driving using the supply of the voltage from the external power source than during the driving using the internal power source.

17. An image display device according to claim 16, wherein the image display device is a notebook personal computer.

18. An image display device comprising at least:
a plurality of data lines;
a plurality of gate lines;
data-line driver circuits electrically connected to the data lines;
scanning-line driver circuits electrically connected to the gate lines;
an interface printed circuit board; and
a controller and an operating-voltage adjusting circuit which are provided on the interface printed circuit board, the controller having a display mode selecting terminal, the controller being capable of varying a clock frequency to be supplied from the controller to the data-line driver circuits, according to a voltage applied to the display mode selecting terminal,
the operating-voltage adjusting circuit having an operating-voltage adjusting terminal capable of controlling the operating-voltage adjusting circuit, the operating-voltage adjusting circuit being capable of varying a voltage to be supplied to at least either the data-line driver circuits or the scanning-line driver circuits, according to a voltage applied to the operating-voltage adjusting terminal.

19. An image display device according to claim 18, wherein the voltage to be supplied to at least either the data-line driver circuits or the scanning-line driver circuits is high when the clock frequency is high.

20. An image display device according to claim 18, wherein a voltage is supplied from the controller to the operating-voltage adjusting terminal, the voltage differing according to the voltage applied to the display mode selecting terminal.
